(19) United States
(12) Patent Application Publication
(10) Pub. No.: US 2016/0305797 A1
(43) Pub. Date: Oct. 20, 2016

(54) Modular System Including Multiple Detachable Sensors

(71) Applicant: Ideation Systems LLC, Austin, TX (US)

(72) Inventors: Lukasz Leszek Pietrasik, Krotoszyn (PL); Adam Waldemar Golinski, Swidnik (PL); Filip Mateusz Kaklin, Edinburgh (GB); Ahmad Hani Zaatari, Austin, TX (US); Daniel James Yee, Austin, TX (US); Mohsen Nakhaeinejad, Austin, TX (US)

(73) Assignee: Ideation Systems LLC, Austin, TX (US)

(21) Appl. No.: 15/043,553

(22) Filed: Feb. 13, 2016

Related U.S. Application Data
(60) Provisional application No. 62/116,143, filed on Feb. 13, 2015.

(51) Int. Cl. G01D 9/00

(52) U.S. Cl. CPC G01D 9/00; H04W 4/008

(57) ABSTRACT

In some embodiments, a sensor apparatus may include a base module having a first interface configured to receive a signal from at least one sensor module. The base module may also include a controller coupled to the first interface and configured to process the signal to produce data, and may include a second interface configured to communicate the data to a computing device.

### CROSS-REFERENCE TO RELATED APPLICATION(S)

This application is a non-provisional of and claims priority to U.S. Provisional Patent Application No. 62/116,143, filed on Feb. 13, 2015 and entitled “Modular System Including Multiple Detachable Sensors”, which is incorporated herein by reference in its entirety.

### FIELD

The present disclosure is generally related to sensor devices, and more particularly to a modular sensor system including multiple detachable sensors.

### BACKGROUND

Sensor devices for use in science classes and in institutes of higher education may include display interfaces as well as interfaces for copying bitmapped images to a storage device, such as a removable floppy disk, a thumb drive, or other storage device. Such sensor devices may include oscilloscopes, voltage and current meters, temperature sensors, other sensors, or any combination thereof. Unfortunately, such sensors are typically wired and may cost hundreds of dollars per device.

### SUMMARY

Embodiments of systems and methods are described below that include a base module which may include a power supply, power management circuitry, and communication circuitry. The base module may be configured to communicate with a computing device, such as a laptop, a smart phone, a desktop computer, another computing device, or any combination thereof through a first communication link, which may be wired or wireless. The base module may also include an interface configured to deliver power to and to communicate with one or more sensor modules, which may be configured to measure a parameter and to communicate measurement data to the base module. In some embodiments, the base module and the sensor modules may cooperate to provide a robust suite of easy-to-use sensors for use in a variety of testing environments, including university, test lab, and garage inventor settings.

In some embodiments, the robust suite may be configured to communicate data to a complementary software program that may be executed by a processor of the computing device. The complementary software program may capture and display data from the sensor modules. The complementary software program may provide a graphical interface including a plurality of user-selectable elements through which a user may interact with the data to label data points, to select between visualizations, to alter color selections, or any combination thereof. Data may be presented in tables, charts, graphs, or any combination thereof.

### BRIEF DESCRIPTION OF THE DRAWINGS

FIG. 1 is a block diagram of a system including a base module and a sensor module, in accordance with certain embodiments of the present disclosure.

FIG. 2 is a perspective view of a sensor apparatus including a base module and a sensor module, in accordance with certain embodiments of the present disclosure.

FIG. 3 is a perspective view of the sensor apparatus of FIG. 2 with the sensor module partially detached from the base module, in accordance with certain embodiments of the present disclosure.

FIG. 4 is a perspective view of a plurality of sensor modules, in accordance with certain embodiments of the present disclosure.

FIG. 5 is top view of a sensor module, in accordance with certain embodiments of the present disclosure.

FIG. 6 is a bottom view of a base module, in accordance with certain embodiments of the present disclosure.

FIG. 7 is a block diagram of a system including a base module, a sensor communication module, and a plurality of sensor modules, in accordance with certain embodiments of the present disclosure.

FIG. 8 is a block diagram of a system including a base module configured to communicate with multiple sensor modules, in accordance with certain embodiments of the present disclosure.

FIG. 9 is a block diagram of a system including a base module configured to communicate with multiple sensor modules, in accordance with certain embodiments of the present disclosure.

FIG. 10 depicts a computing device executing a lab application to provide an interface configured to allow configuration of a base module and one or more transducer modules, in accordance with certain embodiments of the present disclosure.

FIG. 11 depicts a computing device executing a lab application to provide an interface configured to allow a user to customize a teaching lab or curriculum, in accordance with certain embodiments of the present disclosure.

FIG. 12A depicts a plurality of transducers and a base module, in accordance with certain embodiments of the present disclosure.

FIG. 12B depicts a system including a base module, one or more transducers, and a charger in a stacked configuration, in accordance with certain embodiments of the present disclosure.

FIG. 12C depicts a system including a base module, one or more transducers, and a charger in a stacked configuration, in accordance with certain embodiments of the present disclosure.

FIG. 13 depicts a ball including an integrated base module and one or more sensors, in accordance with certain embodiments of the present disclosure.

FIG. 14 depicts a system including a base module and a sensor having an attachment mechanism for coupling to a structure, in accordance with certain embodiments of the present disclosure.

FIG. 15 depicts a system including a base module and multiple sensors magnetically coupled to a structure, in accordance with certain embodiments of the present disclosure.

FIG. 16 depicts a device including a base module and multiple sensors fastened to a substrate, in accordance with certain embodiments of the present disclosure.

In the following discussion, the same reference numbers are used in the various embodiments to indicate the same or similar elements.

### DETAILED DESCRIPTION OF ILLUSTRATIVE EMBODIMENTS

In the following detailed description of embodiments, reference is made to the accompanying drawings which form a part hereof, and which are shown by way of illustrations. It is to be understood that features of various described embodiments may be combined, other embodiments may be utilized, and structural changes may be made without departing from the scope of the present disclosure. It is also to be understood that features of the various embodiments and examples herein can be combined, exchanged, or removed without departing from the scope of the present disclosure.

In accordance with various embodiments, the methods and functions described herein may be implemented as one or more software programs running on a computing device, such as a tablet computer, smartphone, personal computer, server, or any other computing device. Dedicated hardware implementations including, but not limited to, application specific integrated circuits, programmable logic arrays, and other hardware devices can likewise be constructed to implement the methods and functions described herein. Further, the methods described herein may be implemented as a device, such as a computer readable storage device or memory device, including instructions that, when executed, cause a processor to perform the methods. Examples of such storage devices can include non-volatile storage devices, such as flash memories, hard disc drives, compact discs (CDs), other non-volatile memory, or any combination thereof.

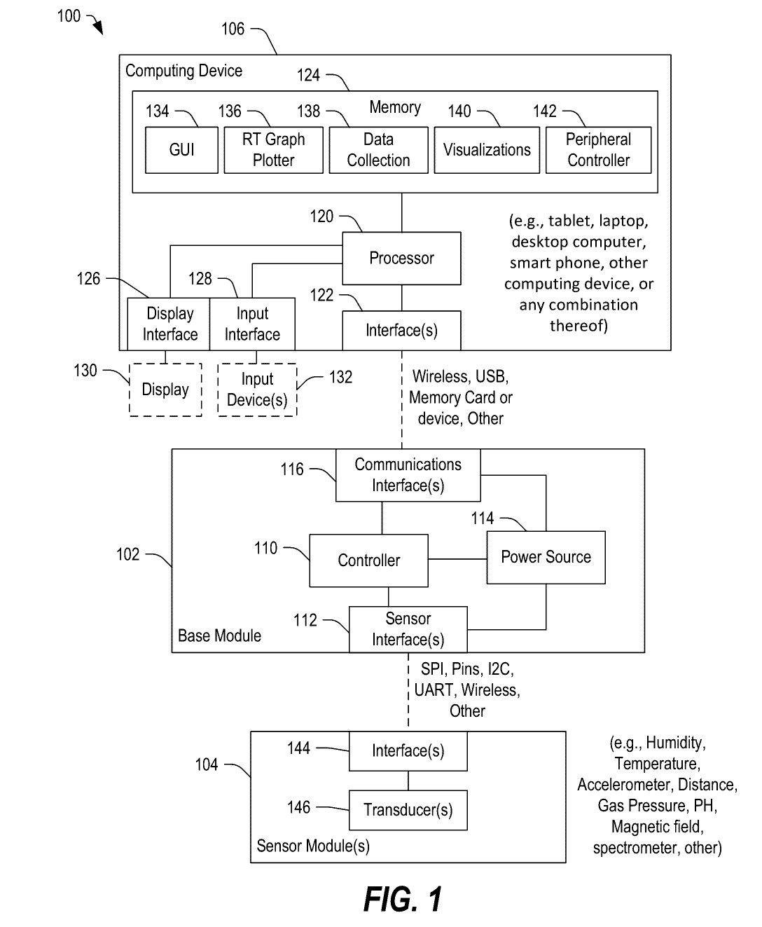

FIG. 1 is a block diagram of a system 100 including a base module 102 and a sensor module 104, in accordance with certain embodiments of the present disclosure. The base module 102 may be configured to communicate with one or more sensor modules 104 and may be configured to communicate with a computing device 106. In some embodiments, the computing device 106 may be a tablet computer, a laptop, a desktop computer, a smart phone, another computing device, or any combination thereof.

The base module 102 may include a controller 110 coupled to a sensor interface circuit 112, which may include one or more sensor interfaces configured to communicate with one or more sensor modules 104. The sensor interface circuit 112 may include a serial peripheral interface (SPI), pins, an inter-integrated circuit (I²C) interface, a universal asynchronous receiver/transmitter (UART) interface, a wireless interface (e.g., Bluetooth®, IEEE 802.11x, or another wireless interface), a universal serial bus (USB) interface, another communications interface, or any combination thereof. The base module 102 may further include a communications interface circuit 116 coupled to the controller 110 and configured to communicate with the computing device 106. The communications interface circuit 116 may include a wireless transceiver, a USB interface, a memory card or flash card interface (such as an interface for a secure digital (SD) card, a mini-SD card, a compact flash memory, a memory stick, a smart media card, another memory device, or any combination thereof), a livewire connection, another type interface, or any combination thereof. In some embodiments, the base module 102 may also include a power source 114. In an alternative embodiment, the base module 102 may receive power from the computing device 106, such as from a universal serial bus (USB) connection. In some embodiments, the power source 114 may include a power supply circuit configured to receive power from an external power supply, such as a plug or outlet. In some embodiments, the power source 114 may include a rechargeable battery 114. The controller 110 may control the communications interface 116, the sensor interface 112, and the power source 114. In some embodiments, the controller 110 may control recharge operations with respect to the power source 114.

The base module 102 may be configured to communicate with and sometimes couple to one or more detachable sensor modules 104. The sensor modules 104 can include gyroscopes, accelerometers, speed sensors, humidity sensors, temperature sensors, accelerometers, inclinometers, altimeters, gas pressure sensors, distance (e.g., range) sensors, acidity/basicity (PH) sensors, magnetic field sensors, spectrometers, other sensors, or any combination thereof. Each sensor module 104 may include a transducer 146 configured to convert a particular parameter into an electrical signal and may include an interface 144 coupled to the transducer 146. The interface 144 may be configured to couple to or otherwise communicate with the sensor interface 112 of the base module 102. In some embodiments, the sensor module 104 may include a rechargeable battery or capacitor, which may be charged when the sensor module 104 is coupled to the base module 102. In some embodiments, the sensor module 104 may be powered by the base module 102.

The computing device 106 may include a processor circuit 120, which may include one or more processors. The computing device 106 may further include an interface 122, which may be configured to communicate with the base module 102 via communications link, which can be wired or wireless. Additionally, the computing device 106 may include a memory device 124, which may be coupled to the processor 120. The computing device 106 can also include a display interface 126 and an input interface 128, which may be coupled to the processor circuit 120. In some embodiments of the computing device 106, such as a smart phone or tablet computer implementation, the display interface 126 and the input interface 128 may form a touchscreen interface. In some embodiments, such as a desktop computer or laptop computer implementation, the display interface 126 may couple to a display 130 and the input interface 126 may couple to one or more input devices 132, such as a keyboard, a mouse, a track pad, or other input device.

The memory 124 may store data and may store instructions that, when executed, cause the processor 120 to perform various functions and methods. In some embodiments, the memory 124 may include a graphical user interface module 134 that, when executed, may cause the processor 120 to generate an interface and to provide the interface to the display interface 126 for presentation via an integrated display, a touchscreen or via the display 130. The interface may include data corresponding to electrical signals generated by the sensor module 104 and communicated to the base module 102, which may have communicated the data (and optionally other data, such as a time stamp) to the computing device 106. The interface may also include one or more user-selectable elements, such as pull down menus, text inputs, buttons, links, other selectable elements, or any combination thereof. In some embodiments, at least one of the menus, links, or buttons may be accessible by a user to select a visualization of the data from a plurality of possible visualizations, such as selecting between a table, a bar graph, a line graph, another visualization, or any combination thereof. The interface may also include a menu, a link, a button, or another selectable option accessible by a user to alter one or more parameters, such as color, font, style or other parameters.

The memory 124 may further include a real time (RT) graph plotter 136 that, when executed, may cause the processor 120 to plot data values in a selected graph format for inclusion within the interface. The memory 124 may also include a data collection module 138 that, when executed, may cause the processor 120 to capture the data from the sensor module 104 and to store the data. In some embodiments, the collection module 138 may store the data in a table, a database, or another format. In some embodiments, the memory 124 may include a visualizations module 140 that may include a plurality of visualizations for representing data, including graphs, maps, images, tables, other visualizations, or any combination thereof. The processor 120 may access one or more of the visualizations 140 in conjunction with the GUI generator 134 and the RT graph plotter 136 to present the data from the sensor module 104 within a selected visualization. The memory 124 may also include a peripheral controller 142 that, when executed, may cause the processor 120 to control the sensor module 104, the base station 102, or any combination thereof.

In some embodiments, the computing device 106 may be replaced with a cloud-based computing system, and the communications interface 116 of the base module 102 may be configured to communicate with the cloud-based system via Ethernet, WiFi, cellular telephone, digital telephone, another communications medium, or any combination thereof. In other embodiments, the base module 102 may be integrated with the computing device 106, such that the sensor modules 104 may communicate directly with the computing device 106. Other embodiments are also possible.

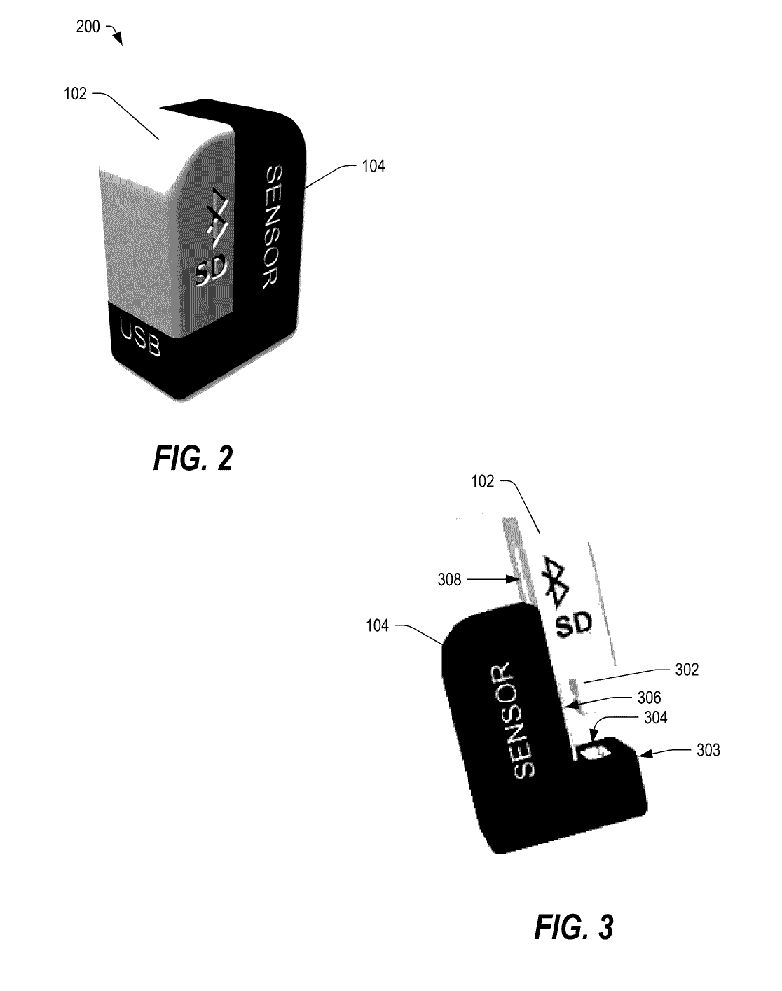

In some embodiments, the sensor module 104 may attach to the base module 102 to form a sensor apparatus. The base module 102 may include an attachment mechanism configured to mate with a corresponding attachment mechanism of the sensor module 104 to secure the sensor module 104. Further, the base module 102 may include an electrical interface configured to mate with a corresponding electrical interface of the sensor module 104 to exchange power, data, instructions, or any combination thereof. One possible example of such a sensor apparatus is described below with respect to FIGS. 2 and 3.

FIG. 2 is a perspective view of a sensor apparatus 200 including a base module 102 and a sensor module 104, in accordance with certain embodiments of the present disclosure. In the illustrated example, the base module 102 may be physically and electrically coupled to the sensor module 104 to form the sensor apparatus. In some embodiments, the sensor apparatus 200 may include rounded exterior corners for aesthetic appeal as well as to reduce the chance that the sensor apparatus 200 may catch on structures. Further, in some embodiments, edges of the sensor module 104 that are configured to mate with the base module 102 (and corresponding edges thereof) may be straight (or rectangular) to facilitate the physical connection or provide stability for the base module 102 when the sensor apparatus 200 is resting on a planar surface, such as a table.

In an embodiment, the base module 102 may be consistent from one sensor type to a next. The base module 102 may include the communications, processing and other circuitry to facilitate communication of sensor data from the sensor module 104 to the computing device 106. The sensor module 104 may include minimal circuitry that is needed to generate an electrical signal in response to a particular parameter to be measured. The base module 102 may provide power and connectivity for the sensor module 104. This allows multiple sensor modules 104 to be produced and sold at low cost and allows the base module 102 to be reused with multiple sensor modules 104.

In some embodiments, a sensor module may be selected from a plurality of sensor modules. The selected sensor module 104 may be coupled to the base module 102 to form the sensor apparatus 200 having a particular measurement capability (such as humidity, temperature, etc.). In some embodiments, the sensor module 104 may be detected from the base module 102. In an example, a first sensor module 104 may be interchanged with a second sensor module by separating the first sensor module from the base module 102 and coupling the second sensor module to the base module 102. One possible example of the detachment process may be understood from the description below with respect to FIG. 3.

FIG. 3 is a perspective view of the system of FIG. 2 with the sensor module 104 partially detached from the base module 102, in accordance with certain embodiments of the present disclosure. In some embodiments, the base module 302 may include a USB connector 302, which may be configured to couple to a USB port 304 within an attachment portion 303 of the sensor module 104. The base module 302 may also include a recessed portion 308 configured to mate with a corresponding extension 306 on an exterior surface of the sensor module 104 adjacent to the attachment portion 303. The recessed portion 308, the corresponding extension 306, the USB connector 302, and the USB port 304 may cooperate to secure the base module 102 to the sensor module 104, physically. In some embodiments, the arrangement of the recessed portion 308 and the corresponding extension 306 may be reversed, such that the extension 306 is part of the base module 102 and the recessed portion 308 is part of the sensor module. In some embodiments, the arrangement of the USB connector 302 and the USB port 304 may be reversed. In some embodiments, the USB connector 302 and the USB port 304 may be replaced with other types of connectors, which may be used for both power and data, such as an RJ-45 connector, an RJ-11 connector, a multi-pin connector, or another type of connector.

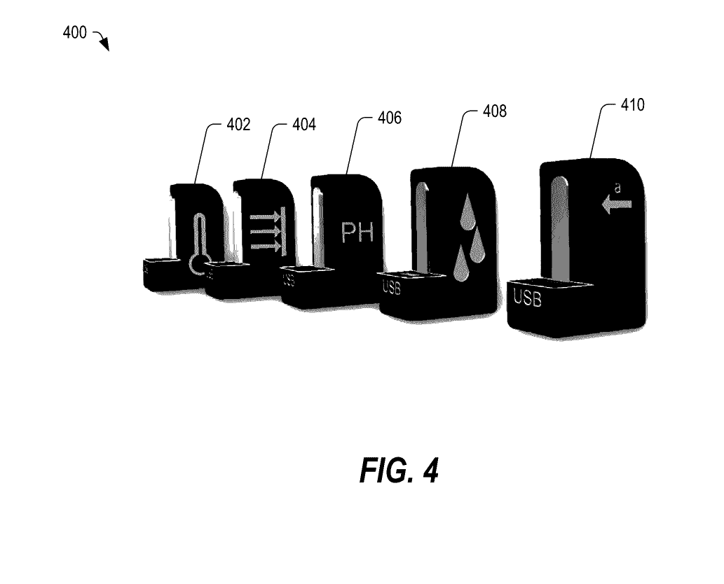

FIG. 4 is a perspective view of a plurality of sensor modules 400, in accordance with certain embodiments of the present disclosure. The plurality of sensor module 400 may include a temperature sensor module 402, a tri-axial accelerometer sensor module 404, a PH sensor module 406, a moisture or humidity sensor module 408, and an acceleration sensor module 410. In some embodiments, one or more of the sensor module functions may be combined, such as combining temperature and PH measurements, temperature and humidity measurements, and so on. While five different sensor modules are shown in FIG. 4, other sensor modules may also be provided, including a magnetometer sensor module, a spectrometer sensor module, an audio sensor module, a seismic sensor module, a gas pressure sensor module, a carbon monoxide (or other type of gas) sensor module, and other sensor modules.

The modular structure of the sensor modules 400 allows for the use of a single base module 102 with multiple sensor modules 104, interchangeably. Further, the number of sensor modules 104 and the types of parameters that they measure may evolve over time and may be constructed to interface with the base module 102 in such a way that the sensor module 104 may convert a measured parameter into an electrical signal, which can be received by the base module 102. Data related to the electrical signal may be communicated to the computing device 106, which may be configured to identify the type of sensor and to apply a particular instruction set to process the data. Thus, the sensor module 104 may be made with a standard interface for communication with the base module 102, and a corresponding set of instructions may be sufficient to enable the computing device 106 to process and interpret the data.

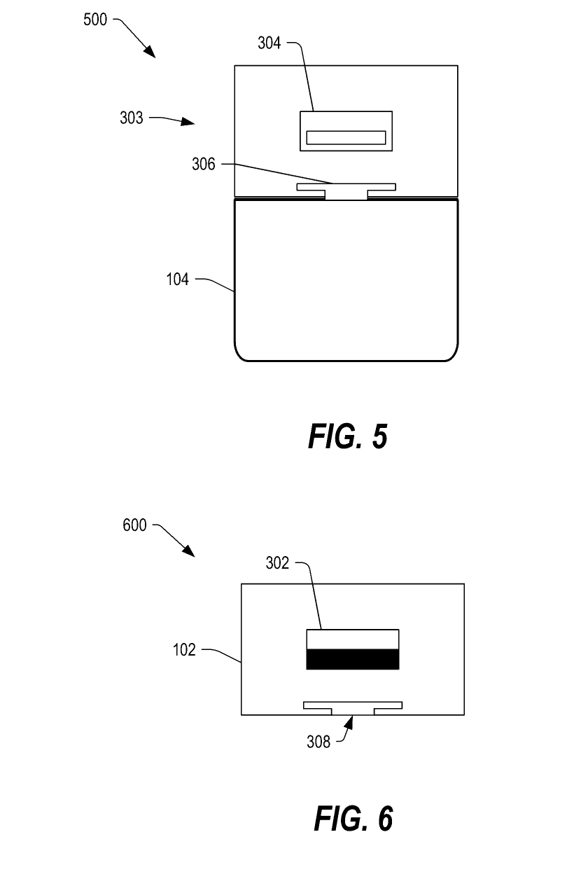

FIG. 5 is top view 500 of a sensor module 104, in accordance with certain embodiments of the present disclosure. The sensor module 104 may include an attachment portion 303 that includes the USB port 304. Further, the sensor module 104 may include the extension 306, which may be sized to mate with a corresponding recess of the base module 102.

FIG. 6 is a bottom view 600 of a base module 102, in accordance with certain embodiments of the present disclosure. The base module 102 may include the USB connector 302 and the recessed portion 308 sized to fit the extension 306. The recessed portion 308 of the base module 102 and the extension 306 of the sensor module 104 may cooperate to secure the base module 102 to the sensor module 104 to form the sensor apparatus.

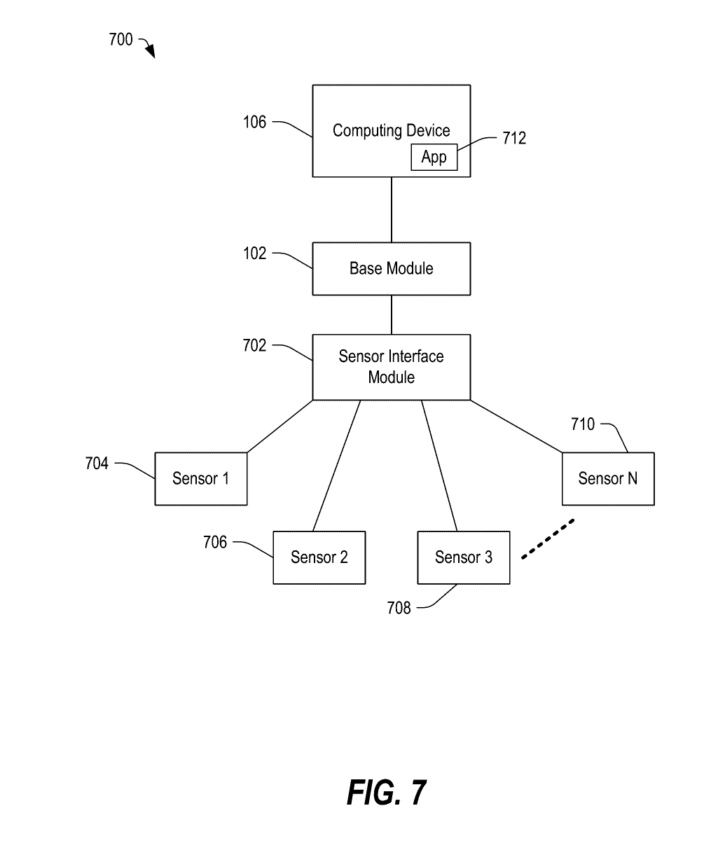

While the embodiments shown in FIGS. 2-6 above depict a base module 102 that may be coupled to a single sensor module (which may include one or more sensors to measure one or more parameters), the base module 102 may also couple to a multiplexing device that may communicate with a plurality of sensor modules. One possible example is described below with respect to FIG. 7.

FIG. 7 is a block diagram of a system 700 including a base module 102, a sensor interface module 702, and a plurality of sensor modules 704, 706, 708, and 710, in accordance with certain embodiments of the present disclosure. The system 700 may include a computing device 106 configured to communicate with the base module 102, which may be coupled to a sensor interface module 702. The sensor interface module 702 may communicate with one or more sensors, such as sensors 704, 706, 708 and 710. Sensors 704, 706, 708, and 710 may be configured to provide electrical signals proportional to one or more parameters to be measured and to communicate the electrical signals (or data related thereto) to the base module 102 via the sensor interface module 702. In some embodiments, the sensors 704, 706, 708, and 710 may measure the one or more parameters, such as the parameters listed with respect to the sensor module 104 in FIG. 1. The sensors 704, 706, 708, and 710 may measure a plurality of parameters substantially simultaneously. Further, the sensors 704, 706, 708, and 710 may be changed relative to the housing of the sensor interface module 704 to provide various sensor units.

In some embodiments, the computing device 106 may include an application 712, which may be executed by the processor 120 and which may include the GUI generator 134, the real-time graph plotter 136, the data collection module 138, the visualizations 140, and the peripheral controller 142 described above with respect to FIG. 1. Further, the application 712 may be configured to communicate at least some portion of the data to the display interface 126, a remote device via a network, or any combination thereof.

While only four sensors 704, 706, 708, and 710 are shown, the sensor interface module 702 may be configured to communicate with more than four sensors and to provide data from the sensors to the base module 102. Thus, the sensor interface module 702 may be an adapter configured to facilitate substantially simultaneous communication between multiple sensors and the base module 102.

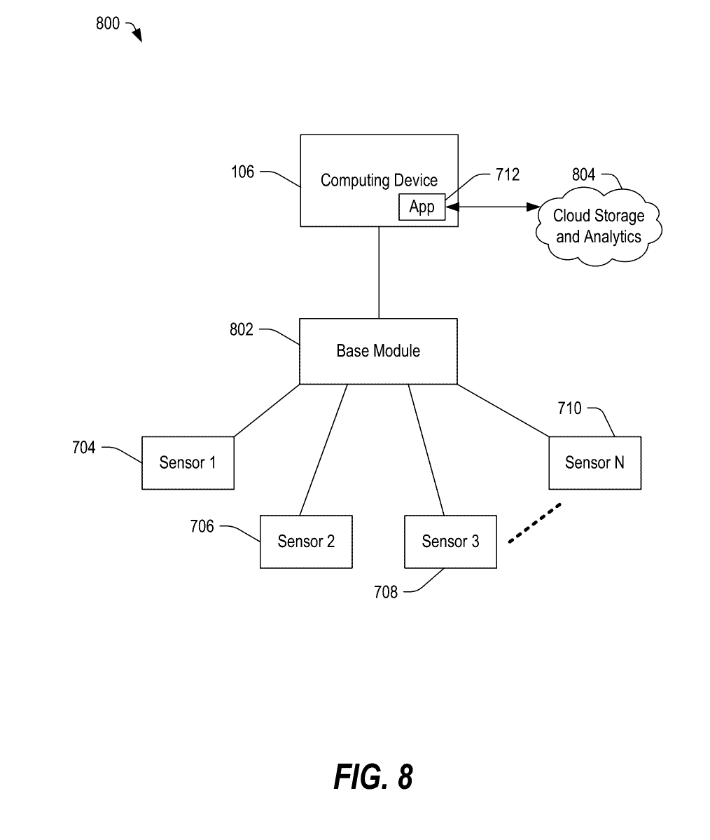

In some embodiments, the base module 102 may be configured to communicate directly with multiple sensor modules. One possible example of such an implementation is described below with respect to FIG. 8.

FIG. 8 is a block diagram of a system 800 including a base module 802 configured to communicate with multiple sensor modules 704, 706, 708, and 710, in accordance with certain embodiments of the present disclosure. The base module 802 may include all of the elements of the base module 102 in FIGS. 1-7 except that the sensor interface 112 may be replaced with a sensor interface configured to communicate with multiple sensor modules substantially simultaneously. The base module 802 may receive data from one or more of the sensors 704, 706, 708, and 710 and may communicate the data and optionally other information to the computing device 106, which may include the application 712 configured to present the data. Further, application 712 may communicate at least some of the data to a cloud storage and analytics server 804, which may process the data and provide processed data and related information to the application 712. The cloud storage and analytics server 804 may one or more of the components of the computing device 106 in FIG. 1.

In some embodiments, the cloud storage and analytics server 804 may be configured to analyze the raw data to produce processed data, which may be provided to the application 712 for presentation to a user. In some embodiments, new analytics modules may be added to the cloud storage and analytics server 804 to enable new features, improvements and so on, without having to update the application 712 and without altering the base module or the sensor modules.

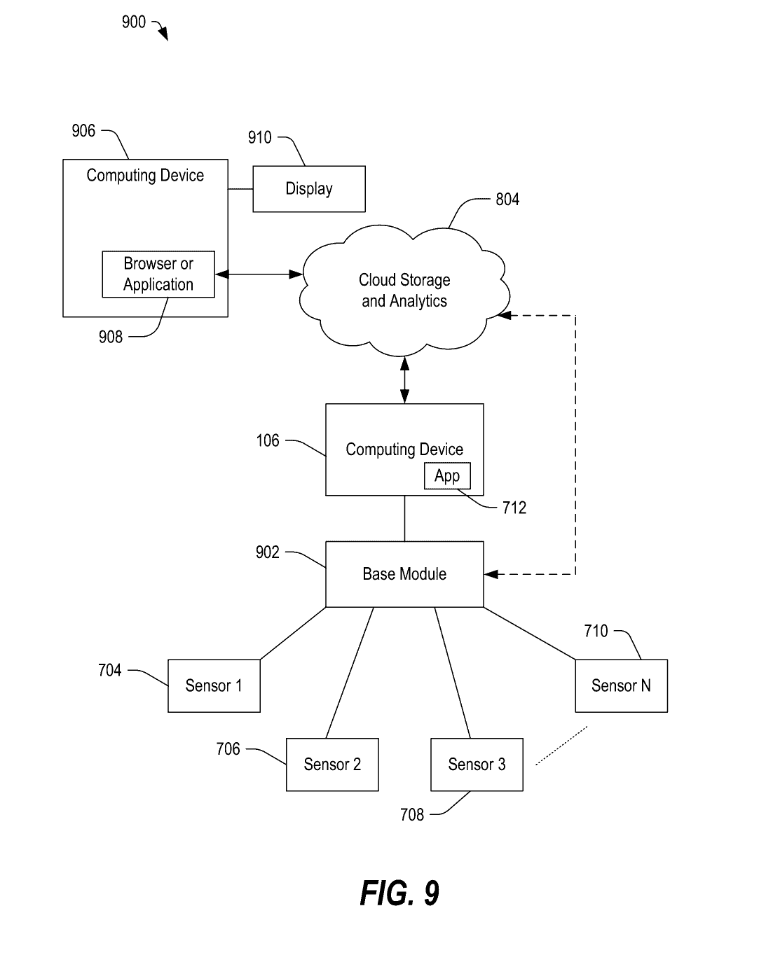

FIG. 9 is a block diagram of a system 900 including a base module 902 configured to communicate with multiple sensor modules 704, 706, 708, and 710, in accordance with certain embodiments of the present disclosure. The base module 902 may also be configured to communicate with the computing device 106, which may include the application 712. In some embodiments, the base module 902 may communicate with cloud storage and analytics system 904, which may be accessible to the computing device 106 or to another computing device 906, which may be executing a browser or other application 908. The computing device 906 may be coupled to a display 910. In some embodiments, the computing device 906 may include a processor, a memory, display and input interfaces, network interfaces, and so on (similar to the computing device 106 in FIG. 1).

In this example, the analytics, visualizations, and processing of the data may be performed by the cloud storage and analytics 804. Further, the resulting processed data and visualizations may be accessed by a user via the browser or other application 908 at computing device 906, via the application 712 at computing device 106, via another computing device, or any combination thereof.

In the illustrated examples, the computing device 106 can communicate with the base module, which may be configured to communicate with a plurality of sensors. In one embodiment, the computing device may be utilized by a student to confirm the connectivity of the various sensors (transducers), to configure the system, and to review data collected by the sensors. In another embodiment, the computing device may be utilized by a teacher to configure a curriculum or to select one or more pre-defined lessons. Other embodiments are also possible.

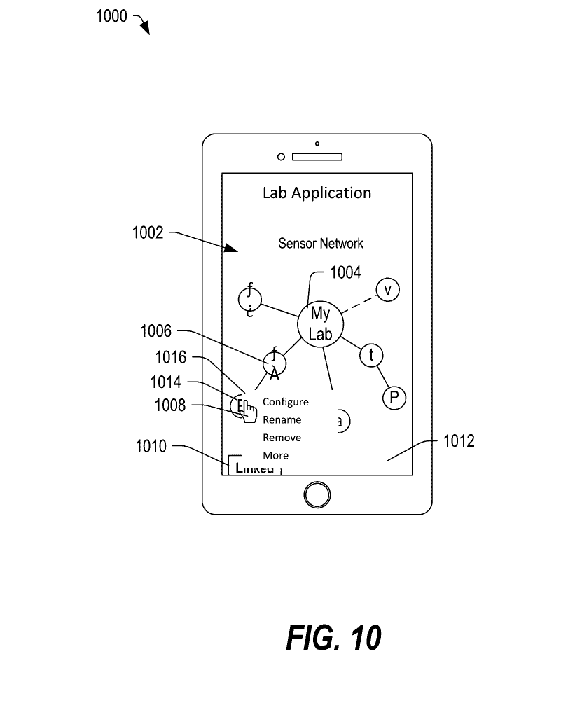

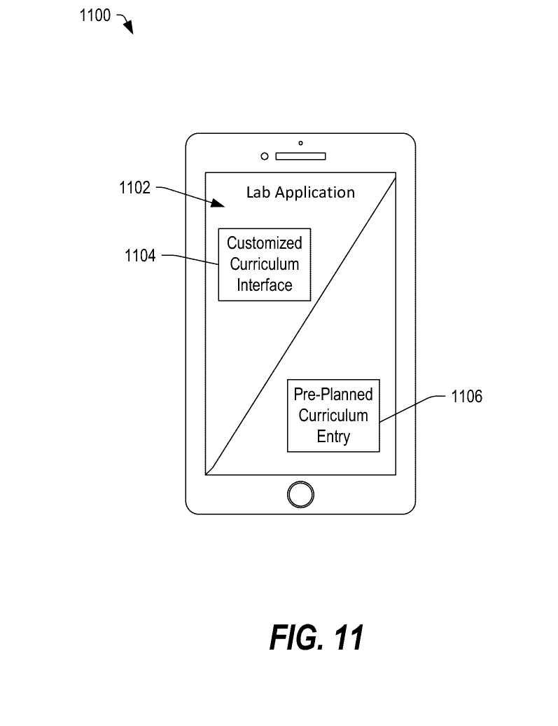

In the illustrated examples of FIGS. 10 and 11 below, a computing device is depicted as a smart phone or tablet computing device. In some embodiments, the computing device may communicate with the base module through a wireless connection, such as a Bluetooth® connection or other short-range wireless connection. In some embodiments, the computing device may communicate with the base module through a wired connection. It should be understood that the computing device includes at least a processor, a memory, a wireless transceiver, and a touchscreen for displaying data and for receiving input selections. One possible example of a computing device is described below with respect to FIGS. 10 and 11.

FIG. 10 depicts a computing device 1000 executing a lab application to provide an interface configured to allow configuration of a base module and one or more transducer modules, in accordance with certain embodiments of the present disclosure. The computing device 1000 includes a touchscreen interface 1002, which may present an interactive interface through which a user may verify a sensor setup and configure a system that includes a base module and multiple sensors. In the illustrated example, the interface includes a plurality of objects, each of which represents a component of the sensor system.

The interface includes a first object (labeled “My Lab”) 1004, which may represent a base module. A plurality of transducers, such as sensors, actuators, and the like, may be represented by objects, such as the object 1006, which may be a transducer, such as a temperature sensor, an accelerometer, a pressure sensor, a velocity sensor, an environmental sensor, a tension sensor, a compression sensor, a current sensor, a voltage sensor, a another sensor, or any combination thereof.

The interface further includes selectable options to configure a particular sensor. In the illustrated example, a user may touch one of the sensors (as indicated by the pointer 1008). In some embodiments, hovering over or touching an object within the interface, such as the object 1014, may cause the interface to display an indicator about whether the device is linked or not linked to the base module 1004. In this example, the indicator 1010 indicates that the sensor 1014 is linked, while the “Not Linked” indicator 1012 is greyed out. In another embodiment, the indicator may be a lock or a solid line, while a dashed line may indicate that configuration is needed.

In the illustrated example, a user may right click or option click the sensor 1014 to open a configuration menu 1016. The configuration menu 1016 may allow a user to configure various parameters of the sensor 1014, such as defining a range, identifying a unit of measure, and so on. Further, the configuration menu 1016 may allow the user to rename the sensor, remove the sensor from the configuration, or access more options. Any number of configuration options may be provided, and the user may access a menu associated with each of the sensors to configure the sensors for a particular experiment. Other embodiments are also possible.

FIG. 11 depicts a computing device 1100 executing a lab application to provide an interface configured to allow a user to customize a teaching lab or curriculum, in accordance with certain embodiments of the present disclosure. The computing device 1100 may include a touchscreen on which an interface 1102 may be presented. The interface 1102 may allow the user to access a customized curriculum interface 1104 to allow a teacher, for example, to define a particular project to be completed using the system in FIG. 10, for example.

The interface 1102 may also include an option accessible by a user to access, select, review, and optionally edit a pre-planned curriculum entry 1106 or a plurality of pre-planned curriculum entries. Depending on which option is selected, the interface may present associated information for display and/or selection. Other embodiments are also possible.

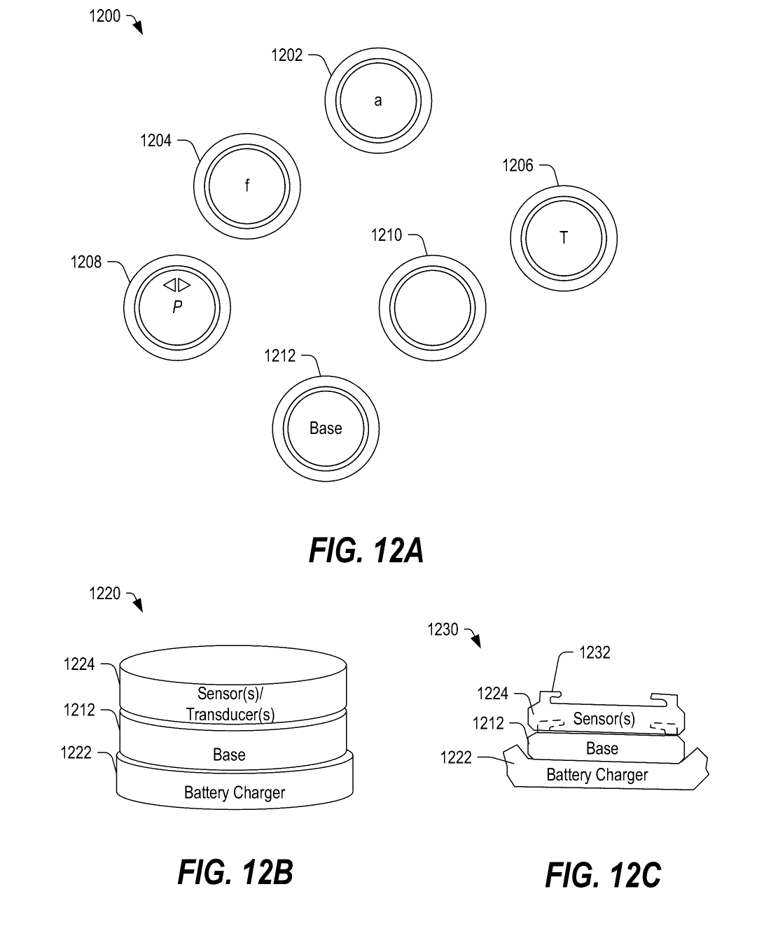

FIG. 12A depicts a system 1200 including a plurality of transducers 1202, 1204, 1206, 1208, and 1210, and a base module 1212, in accordance with certain embodiments of the present disclosure. The transducers 1202, 1204, 1206, 1208, and 1210 are depicted as circular disks, each of which may be configured to measure a particular parameter, such as acceleration, velocity, incline, altitude, temperature, pressure, position, and so on. One of the transducers may be an optical sensor. Other sensors are also possible, including chemical sensors (e.g., pH sensors, etc.), acoustic sensors, optical sensors (e.g., image sensors, infrared sensors, and so on), other sensors, or any combination thereof. One or more of the transducers 1202, 1204, 1206, 1208, and 1210 may be stacked on a base module 1212 to form a multi-sensor device configured to measure selected parameters. The base module 1212 may communicate the measurement data to a computing device.

FIG. 12B depicts a system 1220 including a base module 1212, one or more transducers 1224, and a charger 1222 in a stacked configuration, in accordance with certain embodiments of the present disclosure. The transducers 1224 may be an embodiment of one or more of the transducers 1202, 1204, 1206, 1208, and 1210 in FIG. 12A. In an example, the transducers 1224 and the base module 1212 may be magnetically coupled, mechanically coupled, or otherwise connected to stabilize the stack and to enable communications and provide power.

In an embodiment, the base module 1212 may supply power to the transducers 1224 from a battery. Further, the battery 1224 may be recharged by the battery charger 1222 inductively or via an electrical conductor. In some embodiments, the interconnection may be provided using a pogo-stick type of interconnection, a USB connection, or another electrical connection.

FIG. 12C depicts a system 1230 including a base module 1212, one or more transducers 1224, and a charger 1222 in a stacked configuration, in accordance with certain embodiments of the present disclosure. In this example, the base module 1212 and the sensors 1224 include attachment devices 1232 (such as hooks, clips, clamps) and corresponding recesses to engage the attachment devices 1232 to connect to one another.

In some embodiments, in addition to the sensors 1224 stacked on the base module 1212, one or more additional transducers or sensors may be configured to communicate wirelessly with the base module 1212. Other embodiments are also possible.

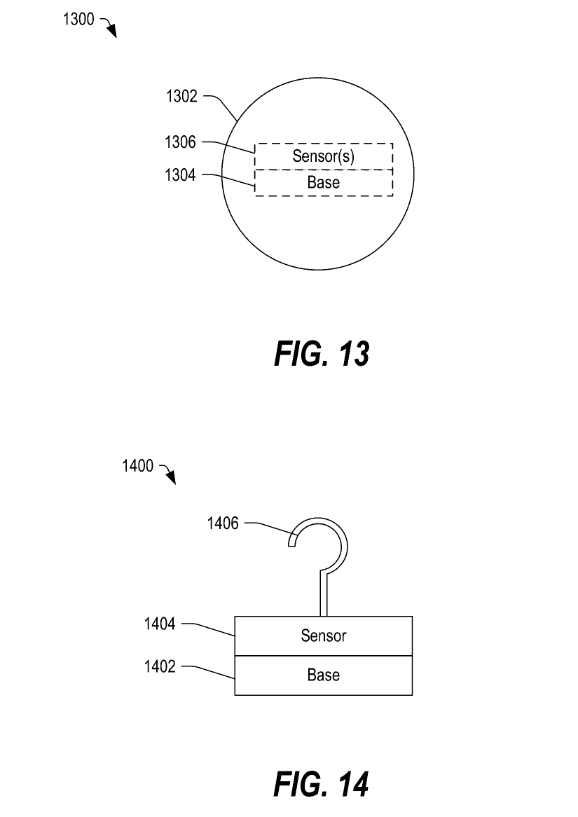

FIG. 13 depicts a ball 1300 including an integrated base module 1304 and one or more sensors 1306, in accordance with certain embodiments of the present disclosure. The ball 1300 may include an outer surface 1302 defining an enclosure sized to receive the base module 1304 and the one or more sensors 1306. In some embodiments, the one or more sensors 1306 may include an impact sensor, a pressure sensor, other sensors, or any combination thereof.

FIG. 14 depicts a system 1400 including a base module 1402 and a sensor 1404 having an attachment mechanism 1406 for coupling to a structure, in accordance with certain embodiments of the present disclosure. In the illustrated example, the attachment mechanism 1406 is depicted as a hook. However, the attachment mechanism 1406 may be implemented as a loop, a clip, a bolt, or another structure configured to engage an external element, such as a string, a weight, an article of clothing, and so on.

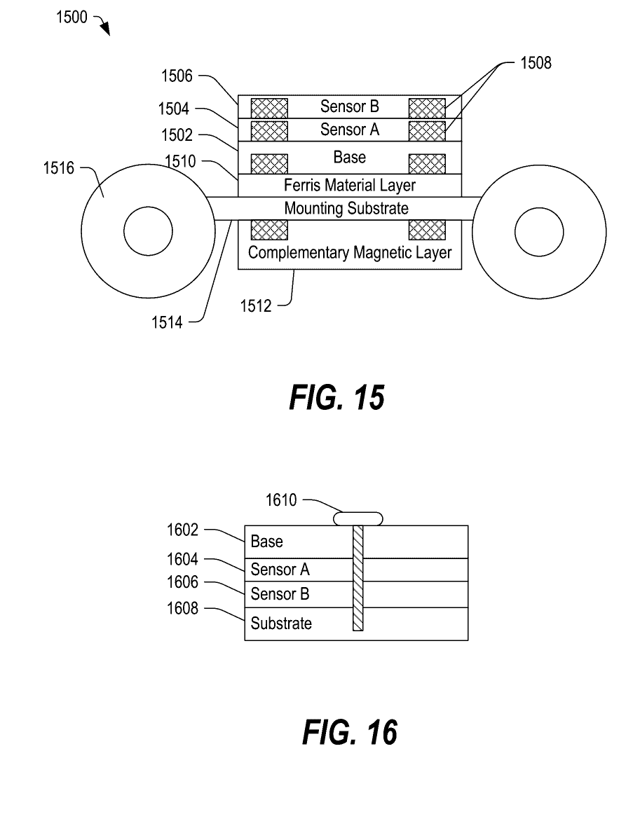

FIG. 15 depicts a system 1500 including a base module 1502 and multiple sensors 1504 and 1506 magnetically coupled to a structure, in accordance with certain embodiments of the present disclosure. In the illustrated example, the base module 1502 and the multiple sensors 1504 and 1506 may each include one or more magnets 1508, which may be configured to magnetically couple the sensors 1504 and 1506 to each other and to the base module 1502. The system 1500 may also include a ferris material layer 1510, which may be coupled to a mounting substrate 1514 (such as a chassis of a rolling structure having wheels 1516). The system 1500 may further include a complementary magnetic layer 1512 that may be configured to magnetically engage the base 1510 and the ferris material layer 1510 through the mounting substrate 1514 to secure the sensor device (base module 1502 and sensors 1504 and 1506) to the substrate 1514.

FIG. 16 depicts a device 1600 including a base module 1602 and multiple sensors 1604 and 1606 fastened to a substrate 1508, in accordance with certain embodiments of the present disclosure. The device 1600 may include a fastener, such as a screw or bolt configured to secure the base module 1602 and multiple sensors 1604 and 1606 to the substrate 1608. In some embodiments, the base module 1602 and the sensors 1604 and 1606 may include a central opening sized to receive the fastener. Other embodiments are also possible.

In conjunction with the systems, modules, circuits, and methods described above with respect to FIGS. 1-16, a modular system is disclosed that includes a data transmitter/collector module (i.e., a base module 102) and a measuring device/sensor (i.e., a sensor module 104). The modularity of product lowers the price of the suite, since the same transmission module can be used with all available sensors, especially since the transmitter is expected to be the most costly. Further, by separating the sensor from the communication module, the communication module can be made to support multiple sensors and multiple communication protocols, such that the base module 102 may be configurable to communicate with one or more sensors (simultaneously or substantially concurrently) and to communicate data from the one or more sensors to the computing device.

In some embodiments, the sensor modules may stack one another and on a base module to form a sensor device. Selection of one or more sensors may configure the device to provide a multi-sensor function. One or more sensors may communicate wirelessly with the base module. Further, the base module may communicate with a computing device through a wired or wireless communication link. In some embodiments, the raw data may be processed by the computing device. In other embodiments, the raw data may be processed by an analytics module accessible through a network, and the processed data may be sent to the computing device for review, display, and optionally further processing.

The modular design can outperform existing sensor devices in terms of price and versatility. Further, the modular design allows for wireless communications and mixed-mode communications that can allow for more flexibility when it comes to designing experiments. The sensor modules may be configured to measure a wide range of parameters, including acceleration, temperature, pressure, humidity, PH, distance, magnetic field, and so on. Further, the modular design allows for different ways of data collection via a micro USB cables, short-range wireless, memory devices, other mechanisms, or any combination thereof.

The software may enable users to collect data on their computer or smartphones and tablets. The data can be saved in commonly utilized file formats, such as the portable document format (PDF), a spreadsheet format, a text format, an image format, or any combination thereof. In some embodiments, the data may be stored in a flat file or in a database structure.

The illustrations, examples, and embodiments described herein are intended to provide a general understanding of the structure of various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. For example, in the flow diagrams presented herein, in certain embodiments, blocks may be removed or combined without departing from the scope of the disclosure. Further, structural and functional elements within the diagram may be combined, in certain embodiments, without departing from the scope of the disclosure. Moreover, although specific embodiments have been illustrated and described herein, it should be appreciated that any subsequent arrangement designed to achieve the same or similar purpose may be substituted for the specific embodiments shown.

This disclosure is intended to cover any and all subsequent adaptations or variations of various embodiments. Combinations of the examples, and other embodiments not specifically described herein, will be apparent to those of skill in the art upon reviewing the description. Additionally, the illustrations are merely representational and may not be drawn to scale. Certain proportions within the illustrations may be exaggerated, while other proportions may be reduced. Accordingly, the disclosure and the figures are to be regarded as illustrative and not restrictive.

What is claimed is:

1. A sensor apparatus comprising:
a base module including:
a first interface configured to receive a signal from at least one sensor module;
a controller coupled to the first interface and configured to process the signal to produce data; and
a second interface configured to communicate the data to a computing device.

2. The sensor apparatus of claim 1, further comprising:
a sensor module including:
a transducer configured to produce the signal in proportion to a parameter to be measured; and
an interface configured to communicate the signal to the first interface of the base module.

3. The sensor apparatus of claim 2, wherein the transducer comprises at least one of an accelerometer, an acidity/basicity (PH) sensor, a humidity sensor, a temperature sensor, a gyroscope, and a magnetometer.

4. The sensor apparatus of claim 1, wherein the first interface comprises at least one of a serial peripheral interface (SPI), pins, an inter-integrated circuit (I²C) interface, a universal asynchronous receiver/transmitter (UART) interface, a short-range wireless interface (e.g., Bluetooth®, IEEE 802.11x, or another wireless interface), and a universal serial bus (USB) interface.

5. The sensor apparatus of claim 1, wherein the second interface comprises at least one of a short-range wireless interface (e.g., Bluetooth®, IEEE 802.11x, or another wireless interface), a universal serial bus (USB) interface, a memory card interface, a wide area network (WAN) interface, a cellular interface, and a digital telephone interface.

6. The sensor apparatus of claim 1, wherein the first interface is configured to communicate with multiple sensors substantially simultaneously.

7. The sensor apparatus of claim 6, wherein the first interface communicates wirelessly with at least one of the multiple sensors.

8. The sensor apparatus of claim 6, wherein the second interface includes a universal serial bus (USB) interface.

9. A system comprising:
a computing device; and
a sensor apparatus including:
a plurality of sensor modules, each of the plurality of sensor modules including a connector interface and configured to produce an electrical signal in response to a measured parameter; and
a base module coupled to the computing device and including a connector interface configured to mate with the connector interface of a selected sensor module.

10. The system of claim 9, wherein the base module includes:
a first interface associated with the connector and configured to receive a signal from at least one sensor module;
a controller coupled to the first interface and configured to process the signal to produce data; and
a second interface configured to communicate the data to the computing device.

11. The system of claim 10, wherein the first interface comprises at least one of a serial peripheral interface (SPI), pins, an inter-integrated circuit (I2C) interface, a universal asynchronous receiver/transmitter (UART) interface, a short-range wireless interface (e.g., Bluetooth®, IEEE 802.11x, or another wireless interface), and a universal serial bus (USB) interface.

12. The system of claim 10, wherein the second interface comprises at least one of a short-range wireless interface (e.g., Bluetooth®, IEEE 802.11x, or another wireless interface), a universal serial bus (USB) interface, a memory card interface, a wide area network (WAN) interface, a cellular interface, and a digital telephone interface.

13. The system of claim 9, wherein the sensor module includes:
a transducer configured to produce the signal in proportional to a parameter to be measured; and
the connector interface configured to communicate the signal to the first interface of the base module.

14. The system of claim 13, wherein the transducer comprises at least one of an accelerometer, an acidity/basicity (PH) sensor, a humidity sensor, a temperature sensor, a gyroscope, and a magnetometer.

15. A sensor apparatus comprising:
a base module including a first interface, a second interface configured to couple to a computing device, and a controller coupled to the first interface and the second interface and configured to process signals received from the first interface to produce data and to provide the data to the computing device via the second interface; and
a sensor module including a transducer configured to produce a signal in proportion to a parameter to be measured and an interface coupled to the transducer and configured to communicate the signal to the first interface of the base module.

16. The sensor apparatus of claim 15, wherein the interface of the sensor module is coupled to the first interface of the base module to receive power and to communicate data.
